(19) United States
(12) Patent Application Publication
(10) Pub. No.: US 2015/0160681 A1
(43) Pub. Date: Jun. 11, 2015

(54) FUNCTION SELECTING METHOD USING OPERATING DEVICE AND FUNCTION SELECTING DEVICE USING THE SAME

(71) Applicant: Hyundai Motor Company, Seoul (KR)

(72) Inventor: Kyu Dae SHIM, Seoul (KR)

(73) Assignee: HYUNDAI MOTOR COMPANY, Seoul (KR)

(21) Appl. No.: 14/284,247

(22) Filed: May 21, 2014

(30) Foreign Application Priority Data
Dec. 11, 2013 (KR) 10-2013-0153629

(51) Int. Cl. G05G 1/02

(52) U.S. Cl. CPC G05G 1/02

(57) ABSTRACT

A method of selecting a function by using an operating device includes pressing a rotatable or pressable operating device. It is determined whether the operating device is pressed for a minimal period of time or longer. Supportable sub functions are displayed on a screen when the operating device is pressed for the minimal period of time or longer. A focus, which selects a function between the sub functions, is moved by rotating the operating device. A sub function at which the focus is positioned is executed according to a release of the press operation of the operating device.

### CROSS-REFERENCE TO RELATED APPLICATION

This application claims under 35 U.S.C. §119(a) the benefit of priority to Korean Patent Application No. 10-2013-0153629 filed in the Korean Intellectual Property Office on Dec. 11, 2013, the entire contents of which are incorporated herein by reference.

### TECHNICAL FIELD

The present disclosure relates to a function selecting method using an operating device. More particularly, it relates to a function selecting method, which is applied to an audio video navigation (AVN) device and the like of a vehicle, thereby rapidly selecting a desired function.

### BACKGROUND

According to development of information and communication technology, various input devices have been developed in addition to a button, keyboard, and joystick as basic input devices. These input devices have been applied to a vehicle, so that in addition to an existing simple press-type button, various input devices, such as a touch screen, can be developed in order to maximize user convenience.

Further, the input device includes an operating device installed at a center fascia and the like around a driver's seat to receive selection of various functions of the AVN device.

FIG. 1 is a diagram illustrating a representative example of an operating device. An operating device 10 of FIG. 1 in a circular shape allows pressing and rotating, thereby serving as an input device through which various functions of the AVN device can be selected.

However, performing the various functions provided by the AVN device by using the existing operating device 10 is inconvenient since the operating device 10 needs to be repeatedly operated several times or to be used together with other function buttons. Further, driver's eyes are distracted while looking for a desired function by repeatedly operating the operating device 10 several times, such that accident risk is increased.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to solve the above-described problems associated with the prior art. The present disclosure relates to a function selecting method using an operating device which can directly execute various functions without unnecessarily increasing operational steps.

According to an exemplary embodiment of the present disclosure, a method of selecting a function by using an operating device includes pressing a rotatable or pressable operating device. It is determined whether the operating device is pressed for a minimal period of time or longer. Supportable sub functions are displayed on a screen when the operating device is pressed for the minimal period of time or longer. A focus, which selects a function between the sub functions, is moved by rotating the operating device. A sub function is executed at which the focus is positioned by releasing the press operation of the operating device.

The method may further include moving the focus which selects the function between supportable functions by rotating the rotatable or pressable operating device before pressing the rotatable or pressable operating device.

According to another exemplary embodiment of the present disclosure, a method of selecting a function by using an operating device includes pressing a rotatable or pressable operating device. A function, where a focus which selects the function is positioned, is selected when the operating device is pressed. Functions are selected while the focus is expanded when the operating device is pressed for a minimal period of time or longer and is rotated.

The step of selecting the functions while the focus is expanded when the operating device is pressed for the minimal period of time or longer and is rotated may include expanding the focus in a downward direction when the operating device is rotated in a clockwise direction. The focus is expanded in an upward direction when the operating device is rotated in a counterclockwise direction.

According to another exemplary embodiment, the method may further include selecting the function to be performed by operating the rotatable or pressable operating device before the step of pressing the rotatable or pressable operating device.

The method may further include processing the selected functions according to the function to be performed when the pressing of the operating device is released after the step of selecting the functions while the focus is vertically or horizontally expanded when the operating device is pressed for the minimal period of time or longer and is rotated.

According to another exemplary embodiment of the present disclosure, a method of selecting a function by using an operating device includes moving a focus selecting a function on a map of a navigator by rotating a rotatable or pressable operating device. The focus is expanded when the operating device is pressed for a minimal period of time or longer and is rotated. A region is set on the map of the navigator in which the focus is positioned as an avoiding region when the press of the operating device is released.

An audio/video/navigation (AVN) device of a vehicle to which the method of selecting the function is applied.

According to another exemplary embodiment of the present disclosure, an apparatus for selecting a function includes a rotatable or pressable operating device. A display is configured to display supportable functions, supportable sub functions, a focus selecting a function, or a navigator. A function supporter is configured to display supportable sub functions of a function at which the focus is positioned on the display when the operating device is pressed for a minimal period of time or longer. A focuser is configured to move the focus or expand the focus by rotating the operating device. A function executor is configured to execute the sub functions or the function at which the focus is positioned or to set a region on a map of the navigator in which the focus is positioned as an avoiding region when the press of the operating device is released.

As described above, the function selecting method according to the present disclosure has the following effects.

First, it is possible to decrease the operation number of the operating device when selecting a necessary function, thereby minimizing user's inconvenience. Accordingly, it is possible to maximize customer satisfaction.

Second, the number of operation times of operating device is decreased during the process of selecting the necessary function, so that driver's eyes are not excessively distributed, thereby reducing an accident risk.

Third, it is possible to execute a desired function only through minimal essential control, thereby providing a user friendly interface.

Other aspects and exemplary embodiments of the disclosure are discussed infra.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the disclosure are discussed in further detail below.

### BRIEF DESCRIPTION OF THE DRAWINGS

The above and other features of the present disclosure will now be described in detail with reference to certain exemplary embodiments thereof illustrated the accompanying drawings which are given hereinbelow by way of illustration only, and thus are not limitative of the present disclosure.

FIG. 1 is a diagram illustrating a representative example of the operating device.

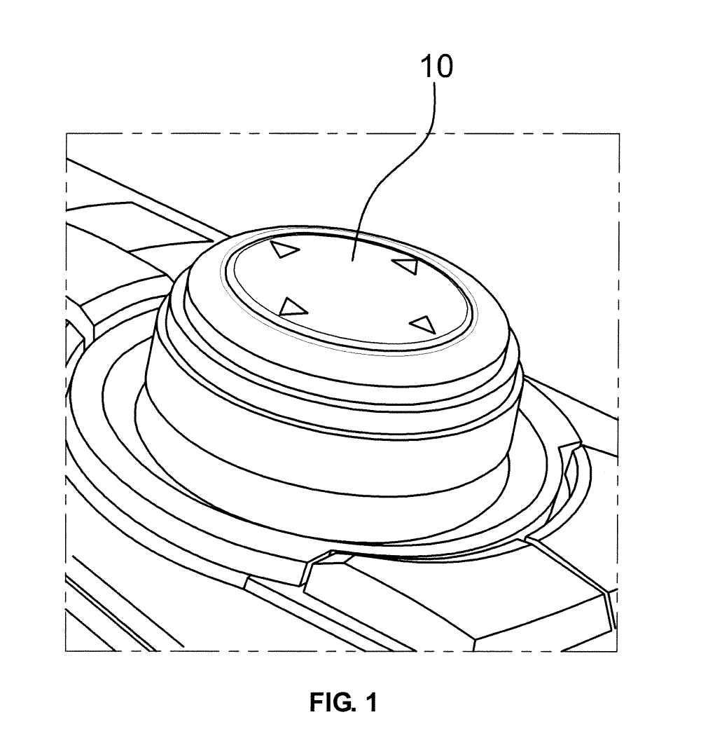

FIG. 2 is a flowchart illustrating a process of performing a function selecting method using an operating device according to an exemplary embodiment of the present disclosure.

FIG. 3 is a diagram illustrating an exemplary embodiment of performance of a function selecting method using the operating device according to the exemplary embodiment of the present disclosure.

FIG. 4 is a diagram illustrating another exemplary embodiment of a function selecting method using the operating device.

FIG. 5 is a diagram illustrating another exemplary embodiment in which a function selecting method using the operating device of the present disclosure is applied to a navigator.

FIG. 6 is a diagram illustrating another exemplary embodiment to which a function selecting method using the operating device of the present disclosure is applied.

It should be understood that the appended drawings are not necessarily drawn to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures.

### DETAILED DESCRIPTION

Hereinafter reference will now be made in detail to various embodiments of the present disclosure, examples of which are illustrated in the accompanying drawings and described below. While the disclosure will be described in conjunction with exemplary embodiments, it will be understood that the present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

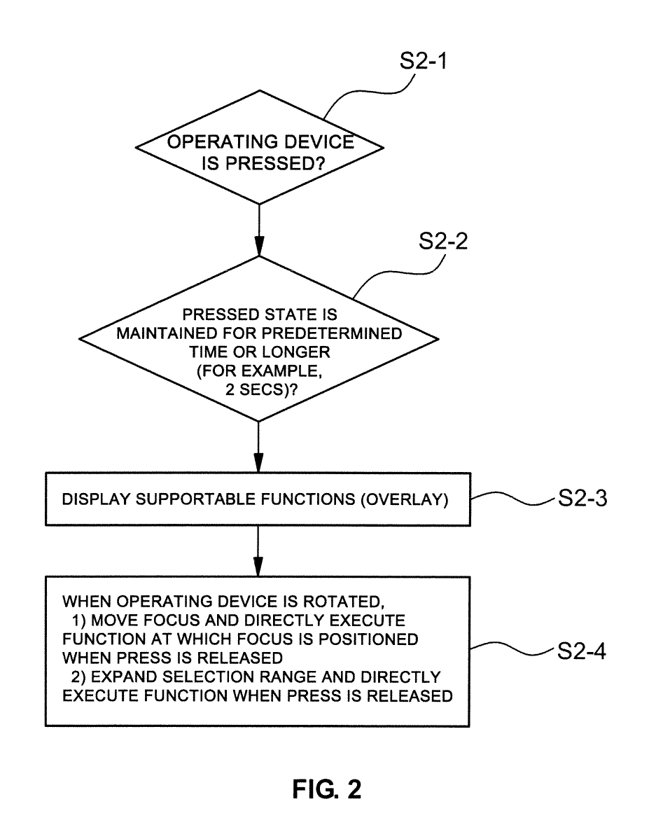

FIG. 2 is a flowchart illustrating a process of performing a function selecting method using an operating device according to an exemplary embodiment of the present disclosure.

First, a function selecting method using an operating device 10 according to an exemplary embodiment of the present disclosure may include a process of determining whether an operating device is pressed (S2-1).

The function selecting method may further include determining whether the operating device 10 maintains a state in which the operating device 10 is pressed for a minimal period of time or longer (S2-2). Here, the minimal period of time may be recognized that a user desires to view a sub menu item of a menu item performing a corresponding function and may be about 2 seconds.

The function selecting method may include displaying supportable functions while overlaying the supportable functions when the operating device 10 is pressed for the minimal period of time or longer (S2-3). Further, the supportable functions may be called sub functions as a meaning of sub functions for a high function. Next, the function selecting method may include selecting a desired sub function by rotating the operating device 10 in left and right directions (S2-4).

Here, as a focus for selecting the function moves, the sub function at which the focus is positioned is activated, and a user is notified that the corresponding function is currently selected. The user may be notified that the corresponding sub function, that is, the sub function at which the focus is positioned, is currently on standby for selection by various methods, such as increasing a size, changing a color, or flickering of a menu item indicating the corresponding sub function to distinguish from menu items indicating other sub functions. When a driver releases the press of the operating device 10, the corresponding sub function at which the focus is positioned may be executed.

Further, a plurality of desired functions may be selected by expanding the focus by rotating the operating device 10 in the left and right directions, and a process of performing the function will be described in detail below.

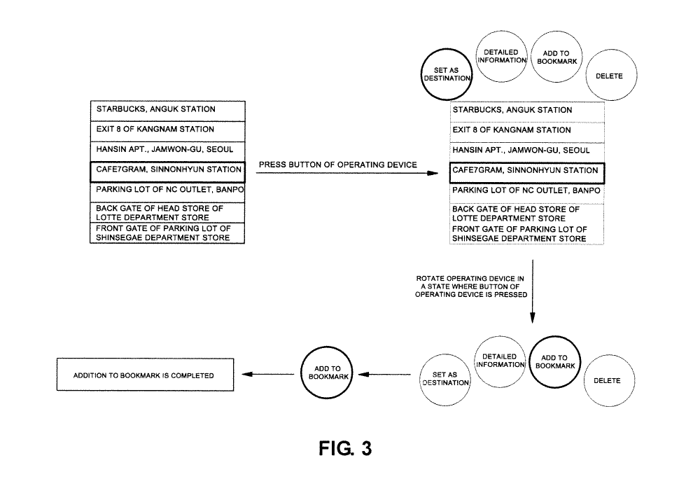

FIG. 3 is a diagram illustrating an exemplary embodiment of performance of a function selecting method using the operating device according to an exemplary embodiment of the present disclosure.

An exemplary embodiment of the present disclosure describes a process of adding a desired destination to a bookmark in a navigator.

First, a user may select a desired destination list item among a plurality of destination list items by rotating the operating device 10. Then, when the desired destination is selected, the user may press the operating device 10. When the operating device 10 is pressed for a minimal period of time, for example, 2 seconds or longer, the sub functions according to an exemplary embodiment of the present disclosure may be displayed on an AVN device display.

FIG. 3 exemplifies destination setting, detailed information, addition to the bookmark, and deletion as the sub function, but the sub function is not limited thereto, and various sub functions, such as movement to a high menu item, may be displayed.

When the sub functions are displayed, the user may select a desired sub function while rotating the operating device 10 in left and right directions. The user may be notified that the corresponding sub function is currently selected while the focus selecting the function moves between the sub functions according to the rotation. That is, the focus is initially positioned at a sub function indicating the destination setting, but when the user rotates the operation device 10 in the right direction while pressing the operating device 10, the focus may sequentially move to a sub function of “detailed information,” and then a sub function of “addition to the bookmark” may be performed.

Next, the function selecting method may include releasing a press operation of the operating device 10. In FIG. 3, the activated sub function menu item, which is activated while the operating device 10 is being released, is the sub function of a “bookmark”, and thus “café7gram, Sinnonhyun”, which is one of destination addresses as shown in FIG. 3, may be added to a bookmark.

As described above, according to the function selecting method using the operating device according to an exemplary embodiment of the present disclosure, from the step of searching for the sub menu item in the high menu item to the step of executing the sub menu item are simply performed through the processes of pressing, rotating, and releasing, thus decreasing the number of processes for operating the operating device 10 and improving user convenience.

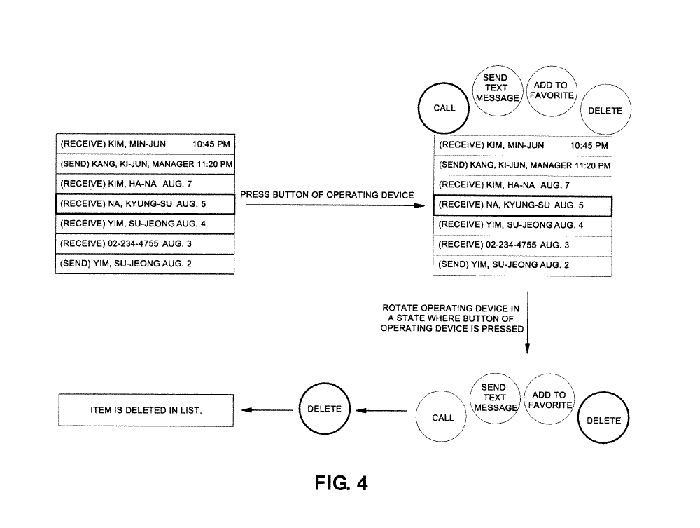

FIG. 4 is a diagram illustrating another exemplary embodiment of the function selecting method using the operating device. FIG. 4 illustrates a step of displaying a call list through a display of the AVN device to a user and deleting one list item in the call list.

First, a user may search for a desired list item in the call list by rotating the operating device 10. In another exemplary embodiment, as an example, “(receive) NA, Kyung-Su”, which is one of desired call receivers as shown in FIG. 4, is selected. In order to delete the list item, the user may press the operating device 10.

According to the performance of the press operation, the function selecting method using the operating device according to another exemplary embodiment of the present disclosure may include providing the user with a sub function through the display device.

Examples of the sub function provided herein include “call”, “send a text message”, “addition to Favorite”, and “deletion”, but the sub function is not limited thereto, and various sub functions may be provided in accordance with a situation.

When the sub function is displayed, the user may select a desired sub function by rotating the operating device 10 in left and right directions. In another exemplary embodiment of the present disclosure, the function selecting method may include rotating the operating device 10 in the right direction in order to move a focus positioned at “call” to the sub function of “deletion”.

When the focus is positioned at the sub function of “deletion”, the user may release the press operation of the operating device 10. According to the release of the press operation, the list item of “(receive) NA, Kyung-Su” may be deleted.

As described above, according to another exemplary embodiment of the present disclosure, it is possible to conveniently execute a function, such as the deletion or the addition of the call list item or the sending of a text message in a vehicle.

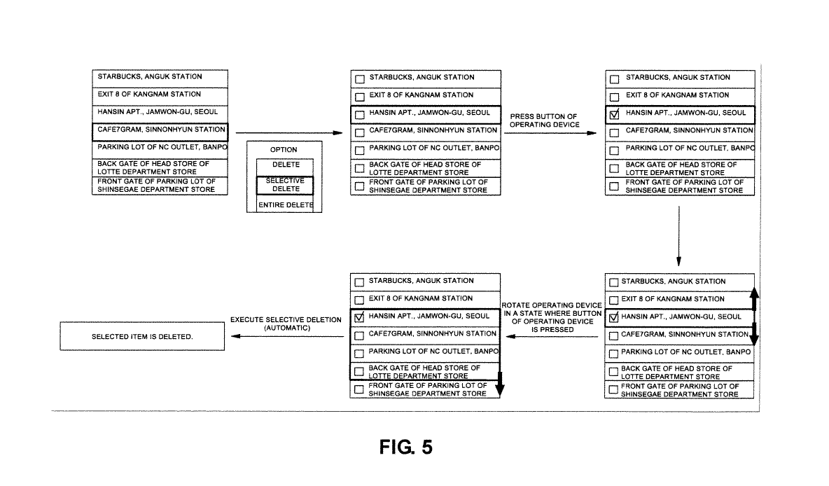

FIG. 5 is a diagram illustrating another exemplary embodiment in which the function selecting method using the operating device of the present disclosure is applied to a navigator.

According to another exemplary embodiment of the present disclosure, a process of selecting and deleting a plurality of list items in a recent destination list of the navigator at once.

A user may first open an option window of a recent destination list, and than may select an option of “selective deletion.” The option selecting process may be appropriately implemented according to the function selecting method using the operating device of the present disclosure. After the “selective deletion” option is checked, the user may search for a destination of which deletion is desired in the recent destinations.

A situation when “Hansin Apt., Jamwon-gu, Seoul”, which is one of recent destination addresses as shown in FIG. 5, is selected by rotating the operating device 10 of another exemplary embodiment, is described.

The user may press the operating device 10. Accordingly, the operating device 10 may select “Hansin Apt., Jamwon-gu, Seoul”, which is the corresponding list item while moving in a downward direction. Then, when the operating device 10 is pressed for a minimal period of time or longer, a focus capable of selecting a function, through which a selection range is vertically expandable, may be displayed through the display device. The focus may be implemented by an arrow or by making list items darker than the selected list item to notify that the corresponding list item is selected. However, the present disclosure is not limited, and the selection of the corresponding list item may be notified by various methods.

Next, the user may rotate the operating device 10. According to the rotation of the operating device 10, a plurality of list items may be selected in a recent destination list. In this case, the list items may be selected according to a vertical or horizontal enlargement of the focus by the rotation.

That is, when the user rotates the operating device 10 in a right direction, i.e., a clockwise direction, lower side list items from the first selected list item may be continuously selected in a downward direction. Further, when the user rotates the operating device 10 in a left direction, that is, a counterclockwise direction, upper side list items from the first selected list item may be continuously selected. However, the selection of the list items is not limited thereto, and the upper and lower list items may be simultaneously selected according to the rotation. In a case where the recent destination list items are arranged in a row, the list items may be selected while the focus is horizontally expanded. Further, when the press operation of the operating device 10 is released, the selected list item may be deleted.

As described above, according to the function selecting method using the operating device of the present disclosure, the plurality of list items may be simultaneously selected, and the desired function may be executed at once through the simple operations of pressing, rotating, and releasing.

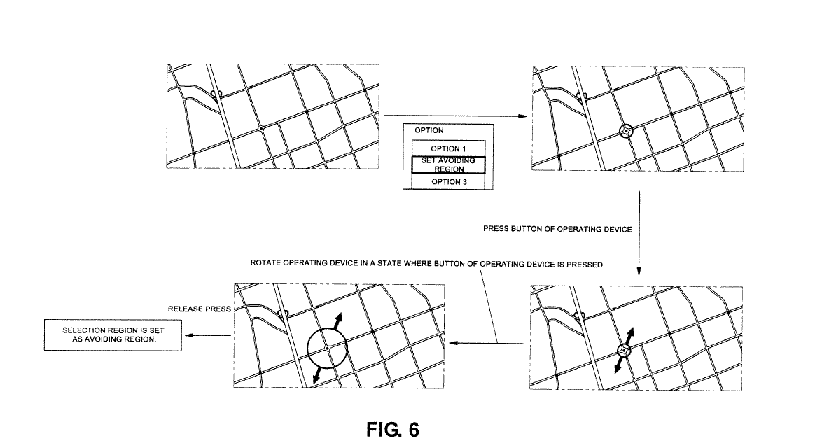

FIG. 6 is a diagram illustrating another exemplary embodiment to which a function selecting method using the operating device of the present disclosure is applied.

The function selecting method using the operating device according to another exemplary embodiment is an exemplary embodiment describing a process of setting a corresponding region as an evasive route due to traffic congestion in a navigator.

First, a user may select an option of “setting avoiding region” by opening an option window. After selecting “setting avoiding region”, the user may select a point desired to be avoided on a map displayed on a display of the AVN device.

In this case, the user may select the point desired to be avoided by moving a circular focus displayed on the map while rotating the operating device 10 in left and right directions. However, the focus may be changed to have various shapes, such as a quadrangle or circular shape.

When the user selects the point desired to be avoided, the user may press the operating device 10. When the user presses the operating device 10 for a minimal period of time or longer with the pressure and rotates the operating device 10, a circular focus size may be increased or decreased. For example, when the user rotates the operating device 10 in a clockwise direction, the focus may be expanded, and when the user rotates the operating device 10 in a counterclockwise direction, the focus may be reduced.

After the focus has been adjusted to an appropriate size, in order to set the corresponding region as the avoiding region, the user may release the press operation of the operating device 10. Then, the operating device 10 is returned to an original state, and the region on the map selected by the focus may be set as an avoiding region.

As described above, when the point desired to be avoided is selected on the map of the navigator according to another exemplary embodiment of the present disclosure, the user may execute a desired function by pressing, rotating, or releasing the press operation.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A method of selecting a function by using an operating device, the method comprising steps of:
pressing a rotatable or pressable operating device;
determining whether the operating device is pressed for a minimal period of time or longer;
displaying supportable sub functions on a screen when the operating device is pressed for the minimal period of time or longer;
moving a focus selecting a function between the sub functions by rotating the operating device; and
executing a sub function at which the focus is positioned by releasing the press operation of the operating device.

2. The method of claim 1, further comprising:
moving the focus which selects the function between supportable functions by rotating the rotatable or pressable operating device before the step of pressing the rotatable or pressable operating device.

3. A method of selecting a function by using an operating device, the method comprising steps of:
pressing a rotatable or pressable operating device;
selecting a function at which a focus selecting the function is positioned when the operating device is pressed; and
selecting functions while the focus expands when the operating device is pressed for a minimal period of time or longer and is rotated.

4. The method of claim 3, wherein the step of selecting the functions while the focus expands when the operating device is pressed for the minimal period of time or longer and is rotated comprises:
expanding the focus in a downward direction when the operating device is rotated in a clockwise direction; and
expanding the focus in an upward direction when the operating device is rotated in a counterclockwise direction.

5. The method of claim 3, further comprising:
selecting the function to be performed through operating the rotatable or pressable operating device before the step of pressing the rotatable or pressable operating device.

6. The method of claim 5, further comprising:
processing the selected functions according to the function to be performed when the step of pressing the operating device is released after the step of selecting the functions while the focus is vertically or horizontally expanded when the operating device is pressed for the minimal period of time or longer and is rotated.

7. A method of selecting a function by using an operating device, the method comprising steps of:
moving a focus selecting a function on a map of a navigator by rotating a rotatable or pressable operating device;
expanding the focus when the operating device is pressed for a minimal period of time or longer and is rotated; and
setting a region on the map of the navigator in which the focus is positioned as an avoiding region when the press of the operating device is released.

8. An audio video navigation (AVN) device of a vehicle to which the method of selecting the function of claim 1 is applied.

9. An apparatus for selecting a function, the apparatus comprising:
a rotatable or pressable operating device;
a display configured to display supportable functions, supportable sub functions, a focus which selects a function, or a navigator;
a function supporter configured to display supportable sub functions of the function at which the focus is positioned on the display when the operating device is pressed for a minimal period of time or longer;
a focuser configured to move the focus or expand the focus by rotating the operating device; and
a function executor configured to execute the sub functions or the function at which the focus is positioned or to set a region on a map of the navigator in which the focus is positioned as an avoiding region when the press of the operating device is released.

10. An audio video navigation (AVN) device of a vehicle to which the method of selecting the function of claim 2 is applied.

11. An audio video navigation (AVN) device of a vehicle to which the method of selecting the function of claim 3 is applied.

12. An audio video navigation (AVN) device of a vehicle to which the method of selecting the function of claim 4 is applied.

13. An audio video navigation (AVN) device of a vehicle to which the method of selecting the function of claim 5 is applied.

14. An audio video navigation (AVN) device of a vehicle to which the method of selecting the function of claim 6 is applied.

15. An audio video navigation (AVN) device of a vehicle to which the method of selecting the function of claim 7 is applied.
